(19) United States
(12) Patent Application Publication
(10) Pub. No.: US 2009/0049449 A1
(43) Pub. Date: Feb. 19, 2009

(54) METHOD AND APPARATUS FOR OPERATING SYSTEM INDEPENDENT RESOURCE ALLOCATION AND CONTROL

(76) Inventor: Srinidhi VARADARAJAN, Santa Clara, CA (US)

Correspondence Address: Arent Fox LLP, 555 West Fifth Street, 48th Floor, Los Angeles, CA, 90013, US

(21) Appl. No.: 12/179,477

(22) Filed: Jul. 24, 2008

Related U.S. Application Data
(60) Provisional application No. 60/955,973, filed on Aug. 15, 2007.

(51) Int. Cl. G06F 9/50

(52) U.S. Cl. 718/104

(57) ABSTRACT

An apparatus and method for controlling resources in a computing system including receiving an allocation request for a resource; determining whether an allocation limit for the resource has been reached; and, restricting access to the resource upon determination that the allocation limit has been reached.

### CROSS-REFERENCE TO RELATED APPLICATION

This application is non-provisional application of U.S. Provisional Application No. 60/955,973, filed Aug. 15, 2007, the disclosure of the prior application is hereby incorporated in its entirety by reference.

### BACKGROUND

1. Technical Field

The present invention relates generally to the field of computing. Embodiments of the present invention relate to an operating system independent method and apparatus to control resource allocation.

2. Description of Related Art

As the number of processing cores in Central Processing Units (CPU) of servers continues to increase, there is a concomitant increase in the number of applications (consisting of possibly multiple processes and/or threads) allocated to each CPU. One process may, on some platforms, consist of many threads. For example, a multitasking operating system can run multiple processes concurrently or in parallel, and allows a process to spawn “child” processes. The increased number of processes requires highly granular mechanisms to allocate resources to individual application processes/threads to ensure that a server can meet its business objectives. Typically, this has been the domain of multitasking operating system schedulers, which allocate time slices and Input/Output (I/O) cycles to individual processes/threads.

However, multitasking operating system schedulers have several significant disadvantages:
Operating system schedulers typically provide relative priorities among various processes/threads, not absolute resource allocation, which is necessary to provide hard resource allocation bounds.
Interfaces to operating system schedulers vary considerably in sophistication, making it hard to impose business level objectives on operating system scheduling decisions.
Schedulers on different operating systems do not offer the same set of services or capabilities, which prevents common interfaces in multi-operating system environments.
Modifications to the operating system to enhance scheduling capabilities require privileged access to the operating system address space. Such privileged access may not be available at user installations, or may not be desirable due to security or policy restrictions.

### SUMMARY

The present invention provides a transparent approach to implement resource allocation at the individual process/thread level. The approach does not require any changes to the operating system or any kernel level modules or drivers and hence provides an operating system independent mechanism to achieve cross-platform resource allocation. It can be implemented entirely in user-level (user address space), with or without any modifications to existing applications.

In one aspect, the approach is embodied in a method for controlling resources in a computing system includes receiving an allocation request for a resource, determining whether an allocation limit for the resource has been reached; and restricting access to the resource upon determination that the allocation limit has been reached.

In another aspect, a product includes a machine-readable medium and programming embodied in the medium that, when executed by a processor, implements a method for controlling resources in a computing system including receiving an allocation request for a resource; determining whether an allocation limit for the resource has been reached; and restricting access to the resource upon determination that the allocation limit has been reached.

In yet another aspect, an apparatus for controlling resources in a computing system includes means for receiving an allocation request for a resource; means for determining whether an allocation limit for the resource has been reached; and, means for restricting access to the resource upon determination that the allocation limit has been reached.

Related programs, systems and processes are also set forth.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

FIG. 1 illustrates components of a computing system that may be used in connection with checkpoint operations.

FIG. 2 illustrates an architecture that may be used to control resource allocation for a generic operating system.

FIG. 3 illustrates a flow diagram for implementing the control of limits on CPU resources.

FIG. 4 illustrates a flow diagram for implementing the control of memory limits.

FIG. 5 illustrates a flow diagram With a process taken to (a) page memory to satisfy a memory allocation request and (b) access memory stored on an alternate medium.

FIG. 6 illustrates a flow diagram for implementing network and storage data rate limits based on a credit counter.

FIG. 7 illustrates a flow diagram for changing the value of the credit counter.

### DETAILED DESCRIPTION

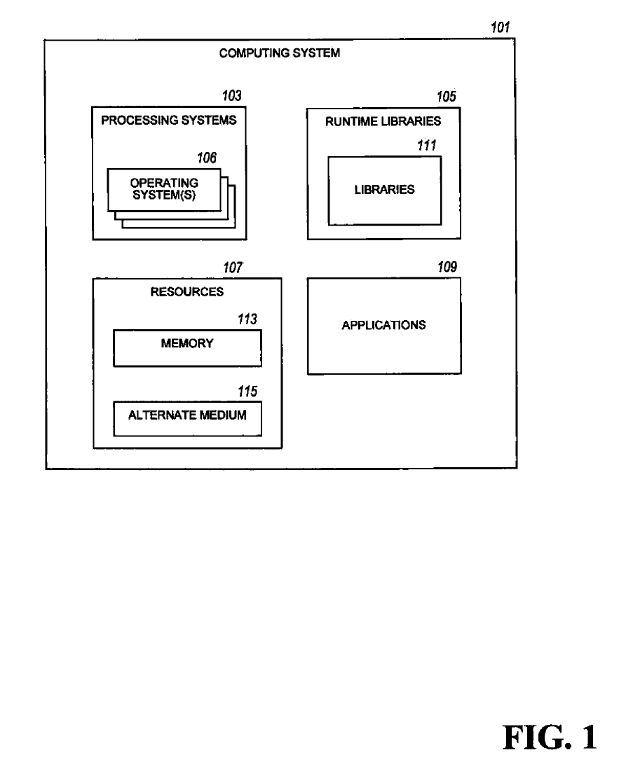

FIG. 1 illustrates components of a computing system that may be used in connection with resource allocation control as shown in FIG. 1, a computing system 101 may include one or more processing systems 103, one or more runtime libraries 105, a collection of resources 107, and one or more applications 109.

The computing system 101 may be any type of computing system. It may be a standalone system or a distributed system. It may be a single computer or multiple computers networked together.

Any type of communication channel may be used to communicate between the various components of the computing system 101, including busses, local area networks (LANs), wide area networks (WANs), the Internet or any combination of these.

Each of the processing systems 103 may be any type of processing system. Each may consist of only a single processor, also referred to as a central processing unit (CPU), or multiple processors. When multiple processors are present, the processors may be configured to operate simultaneously on multiple processes. Each of the processing systems 103 may be located in a single computer or in multiple computers. Each of the processing systems 103 may be configured to perform one or more of the functions that are described herein and other functions.

Each of the processing systems 103 may include one or more operating systems 106. Each of the operating systems 106 may be of any type. Each of the operating systems 106 may be configured to perform one or more of the functions that are described herein and other functions.

Each of the applications 109 may be any type of computer application program. Each may be adopted to perform a specific function or to perform a variety of functions. Each may be configured to spawn a large number of processes, some or all of which may run simultaneously. Each process may include multiple threads. As used herein, the term “application” may include a plurality of processes or threads. Examples of applications that spawn multiple processes that may run simultaneously include oil and gas simulations, management of enterprise data storage systems, algorithmic trading, automotive crash simulations, and aerodynamic simulations.

The collection of resources 107 may include resources that one or more of the applications 109 use during execution. The collection of resources 107 may also include resources used by the operating systems 106.

The resources may include a memory 113. The memory 113 may be of any type of memory. Random access memory (RAM) is one example. The memory 113 may include caches that are internal to the processors that may be used in the processing systems 103. The memory 113 may be in a single computer or distributed across many computers at separated locations. For example, the memory 113 also includes an alternate medium 115. The alternate medium 115 may include memory in the form of non-volatile memory such as magnetic disc-based media, including hard drives or other mass storage. The alternate medium 115 includes networked-based mass storage as well.

The resources 107 may include support for inter-process communication (IPC) primitives, such as support for open files, network connections, pipes, message queues, shared memory, and semaphores. The resources 107 may be in a single computer or distributed across multiple computer locations.

The runtime libraries 105 may be configured to be linked to one or more of the applications 109 when the applications 109 are executing. The runtime libraries 105 may be of any type, such as I/O libraries and libraries that perform mathematical computations.

The runtime libraries 105 may include one or more libraries 111. Each of the libraries 111 may be configured to intercept calls for resources from a process that is spawned by an application to which the library may be linked, to allocate resources to the process, and to keep track of the resource allocations that are made. The libraries 111 may be configured to perform other functions, including the other functions described herein.

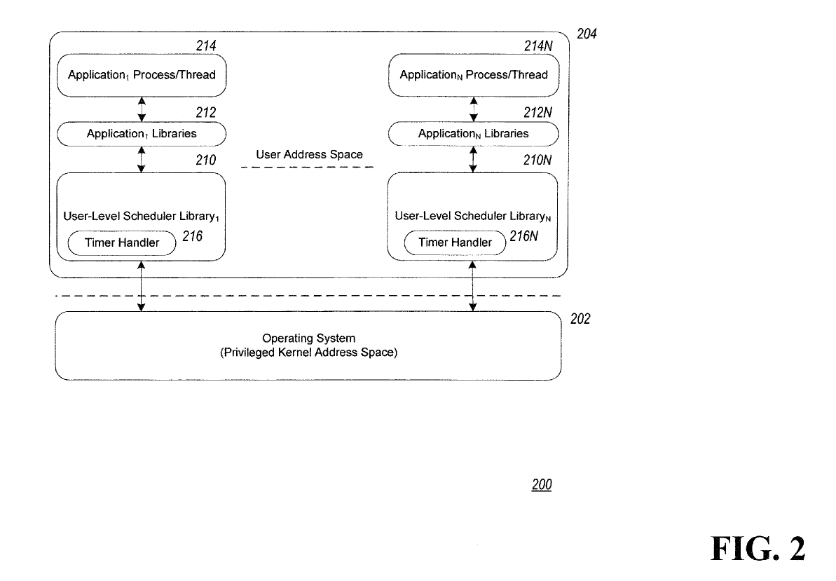

FIG. 2 is a diagram of an architecture 200 that illustrates, in more detail, specific aspects of the computing system 101 having a user address space 204 and an operating system 202. The user address space 204 in FIG. 2 includes a plurality of applications 214 (1-N, application libraries 212_{(1-N)}, and user-level scheduler libraries 210_{(1-N)}. In the following description, one set of applications, application libraries and user-level scheduler libraries will be described. However, it should be noted that the description should be applicable to any number of these processes and libraries. Further, there may be multiple combinations of these applications and libraries.

The various aspects of the resource allocation and control system may be implemented as a user-level library—illustrated as a user-level scheduler library 210 in the user address space 204—that filters lower level operating system scheduling decisions for the operating system 202 according to external resource allocation limits. The user-level scheduler library 210 may be: (a) pre-loaded automatically using dynamic preloading mechanisms such as an LD_PRELOAD instruction or other instructions that instruct a loader to load additional libraries (e.g., an associated application libraries 212), beyond what was specified when it was compiled, into the application 214; (b) linked directly to the application 214, during the compile or link phase; or (c) inserted dynamically into the application 214 by rewriting/re-linking the application binary using common binary rewriting techniques or tools.

Resource allocation limits are typically set by business objectives either directly, or indirectly through some form of higher-level processing. The higher-level processing transforms business objectives into a set of resource allocations to various processes and threads that run on the operating system 202. For example, if a business objective is to obtain a particular transaction latency, then more processing power may be allocated to transaction processing to achieve that transaction latency. The resource allocations may be communicated to the user-level scheduler library 210 using: (a) environment variables, (b) configuration files, (c) command line arguments, or (d) another process through another form of communication.

Once the resource allocations are communicated to the user-level scheduler library 210, the user-level scheduler library 210 may operate by intercepting and regulating operating system calls by the application 214. In one aspect of the resource allocation and control the user-scheduler library 210 provides mechanisms to limit access to the following resources at the level of each process or thread:

(a) Processing System/CPU resources such as processing system 103, including fractions of a CPU core;

(b) Memory such as memory 113;

(c) Network bandwidth and connectivity; and,

(d) Storage bandwidth and capacity.

In totality, the resource allocation and control system provides a general purpose user-level scheduler that can allocate resources in accordance to external objectives across any operating system, without requiring any changes to the operating system.

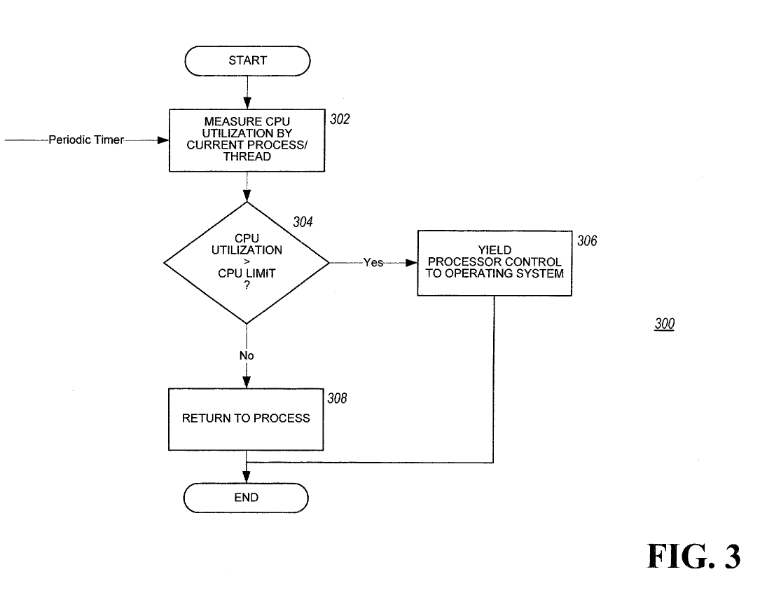

FIG. 3 illustrates a processing system resource control process 300 undertaken to implement limits on CPU resources. To implement limits on access to the CPU, the user-level scheduler library 210 instantiates a periodic timer (either in hardware or software) that invokes a tinier handling function 216 within the user-level scheduler library. The periodicity of the timer may be relatively small, on the order of microseconds or milliseconds. In one aspect of the resource allocation and control system, the period is on the order of 1 millisecond. When the timer handler is invoked, it performs the following actions.

(a) Measures, in step 302, the utilization of the CPU by the process or thread in the application 214 that is running above the user level scheduler library 210.

(ID) If the utilization of the CPU by the process/thread is greater than a previously specified limit, as determined in step 304, it yields control of the CPU back to the operating system 102 in step 306, which may then allocate CPU resources to another process/thread.

(c) If the utilization of the CPU by the process/thread is less than the specified limit, return back to the process/thread from the timer handling function 216 in step 308. This enables the process/thread to continue using CPU resources.

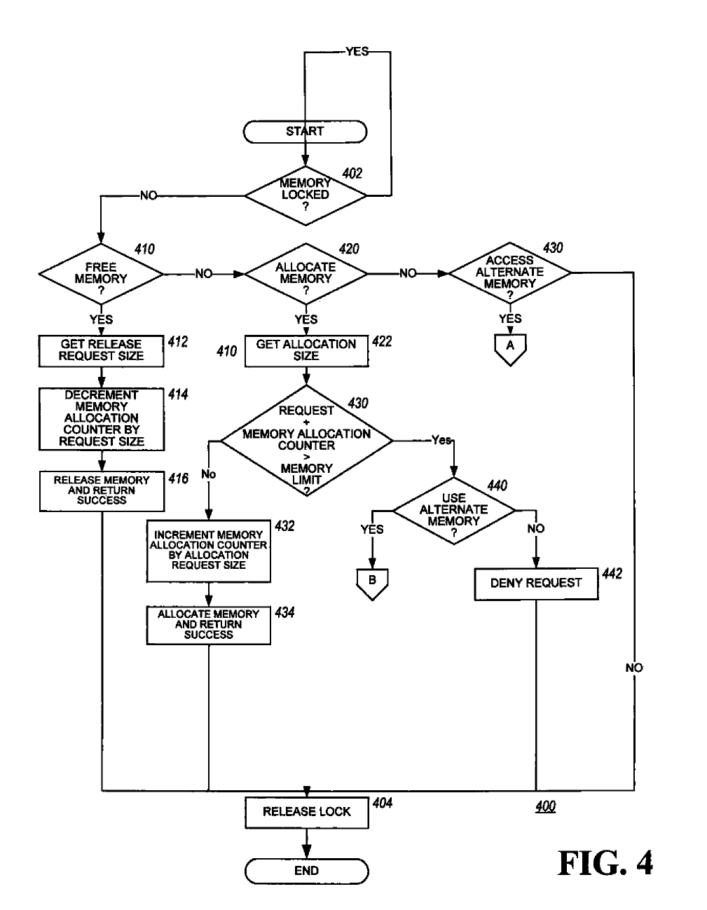

FIG. 4 illustrates a flow diagram for implementing a memory resources limiting process 400. To implement and enforce limits on the use of memory resources, the user-level scheduler library 210 intercepts all memory allocation and release (free) requests from the application 214 to the operating system 202. Initially, in step 402, it is determined if the memory is locked from access. If so, then no memory operations can occur to prevent corruption to the memory. If the memory is not locked, then operation will continue with step 410.

In steps 410, 420 and 430, it is determined whether the request is to free memory, allocate memory, or access memory stored on an alternate memory medium, such as alternate medium 115, respectively. A running counter of the amount of memory allocated to the application 214, referred to herein as a memory allocation counter, is maintained. The memory allocation counter is initially set to a zero. The memory allocation counter is incremented on successful memory allocations and decremented on memory release operations.

If the request is to free memory, then operation will proceed to step 412, where the amount of memory requested to be freed by the application 214 (request size) is retrieved. In step 414, the amount of memory requested to be freed is decremented from the memory allocation counter. The amount of memory requested to be freed is then released and success is returned to the total available memory in step 416.

If the request is not to release but allocate memory, as determined in steps 410 and 420, respectively, then operation proceeds to step 422, where the requested allocation size is obtained. Then, in step 430, it is determined if the memory allocation counter will be greater than the memory limit assigned to the application 214 once the requested size is allocated. Thus, it is determined if the value of the requested size of memory allocation added to the current value of the memory allocation counter is greater then the memory limit assigned to the application 214. If there is enough memory capacity remaining in the memory limit set for the application 214, which means that the memory allocation counter size will not exceed the memory limit once the requested size is allocated to the application 214, the memory allocation counter is incremented in step 432 by the requested size, and memory is allocated in step 434. An indication of successful operation will also be returned and the memory will be unlocked in step 404. If the value of the requested size of memory combined with the value of the memory allocation counter is greater than the memory limit imposed on the application 214, as determined in step 430, and the application 214 attempts to allocate memory as determined in step 420, operation will continue with step 440, where the user-level scheduler library 210 will undertake one of the following user-configurable actions:

1. Deny the memory allocation request in step 442 if the use of alternate medium is not authorized for the application 214, or

2. Satisfy the new request by paging portions of the address space of the application 214 from memory 113 to the alternate medium 115. In general, the operation involves storing the contents of a previously successful memory allocation request by the same process/thread to an alternate medium (primary, secondary or tertiary storage). The selection of which previously successful memory allocation request may be random or based on a selection algorithm. If no such allocations can be found, deny the memory request.

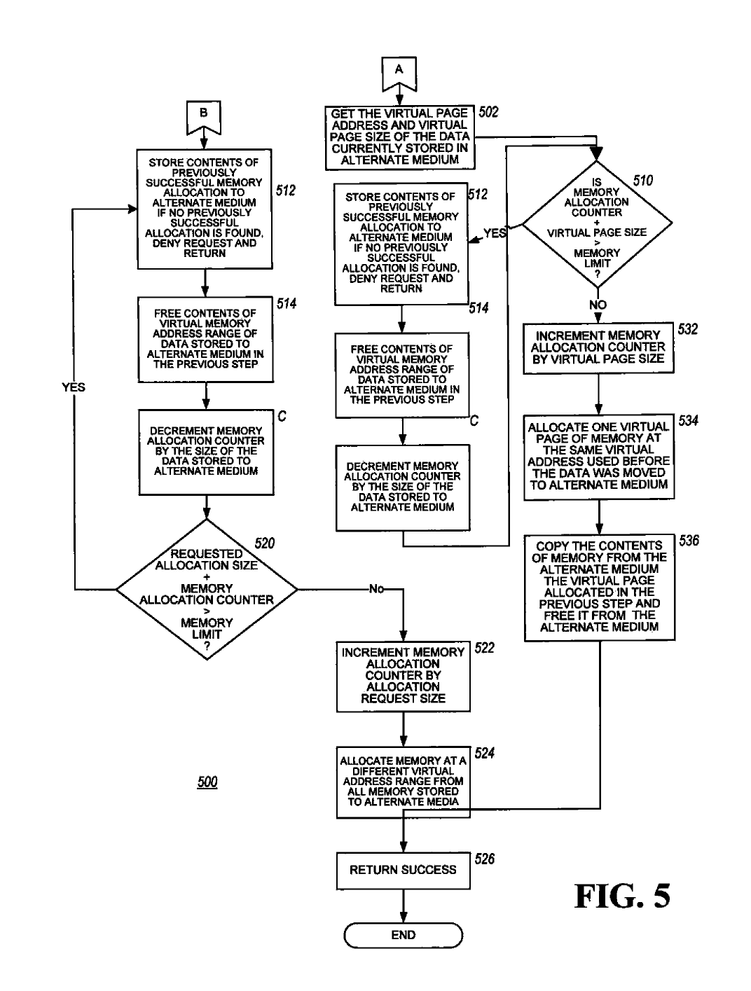

The use of the alternate medium 115 to free the memory space allocated to the application 214 in the memory 113 is achieved by utilizing an alternate medium allocation and access process 500 as illustrated in FIG. 5 and indicated by an off-page reference label B in FIG. 4. In FIG. 5, starting from on-page reference label B, a portion of the previously successfully allocated memory for the application 214 in the memory 113 is moved to the alternate medium 115 in step 512. Then, in step 514, the memory allocation in the memory 113 that has been stored on the alternate medium 115 is released using the process as described in FIG. 4. Also, in step 516, the running counter of the memory in the memory 113 allocated to the application 214 is decremented by the size of the released allocation. In one aspect of the alternate medium allocation and access process 500, each allocation that was made in FIG. 4 may be of a different request size. Thus, the previously allocated memory that was released from the memory 113 may not be sufficient in size to allow the current memory allocation request to be fulfilled.

In step 520, it is determined if the requested size of the memory allocation added to the memory allocation counter will exceed the memory limit set for the application 214. If so, then operation will return to step 512, where more memory in the memory 113 may be released to accommodate the request. Ostensibly, steps 512-520 will continue until enough memory in the memory 113 is released to accommodate the requested allocation. Thus, if the sum of the size of the current memory allocation request and the memory allocation counter is greater than the memory limit on the application 214, steps 512-520 will be repeated until sufficient memory in the memory 113 has been moved to the alternate medium 115 and released to satisfy the current request. Once enough memory in the memory 113 has been released to satisfy the current memory allocation request, then operation continues with step 522.

In step 522, the memory allocation counter is incremented by the allocation request size in the request that is being fulfilled. Then, in step 524, memory in the memory 113 is allocated to the application 214 to fulfill the request and a successful allocation message is returned to the application 214 in 526.

Referring back to FIG. 4, if the request is determined to be a request to access alternate medium in step 430, then operation continues from the off-page reference label A on FIG. 4 to the on-page reference label A in the alternate medium allocation and access process 500 of FIG. 5, where, in step 502, the virtual page address and the virtual page size of the data that is stored in the alternate medium 115 is retrieved. The memory stored in the alternate medium 115 needs to be moved to the memory 113 before it can be used by the application 214. Thus, if an access request is made for memory stored in the alternate medium 115, the request will be treated as a new memory allocation request, with the virtual page size of the memory to be retrieved from the alternate medium 115 used as the size of the memory allocation request. In step 510, it is determined if the memory allocation counter plus the virtual page size is greater than the memory limit for the application 214. If yes, then operation proceeds with step 512, where memory is release in the memory 113 to free up enough memory to satisfy the allocation request caused by the request to retrieve the memory from the alternate medium 115.

If it is determined in step 510 that the sum of the memory allocation counter and the virtual page size does not exceed the memory limit set for the application 214, then enough memory can be allocated to satisfy the memory access request from the alternate medium 115. Operation will continue with step 532, where the memory allocation counter will be incremented by the virtual page size. Then, the memory retrieval request is fulfilled by allocating a virtual page of memory at the same virtual memory address used before the data was moved to the alternate medium in step 534. When the memory has been successfully allocated, the contents of the memory location are retrieved by reading it from the alternate medium. Specifically, the contents of the memory from the alternate medium 115 is copied to the memory 113 before it is freed from the alternate medium 115 in step 536. A successful retrieval message is then returned to the application 214 in step 526.

Network limits on data transfer rate and network connectivity may also be imposed on the application 214. In one aspect of the resource allocation and control system, network data transfer rate limits are implemented by intercepting all network communication requests, including but not limited to opening network connections, sending and receiving data and closing network connections between the application 214 and the operating system 202.

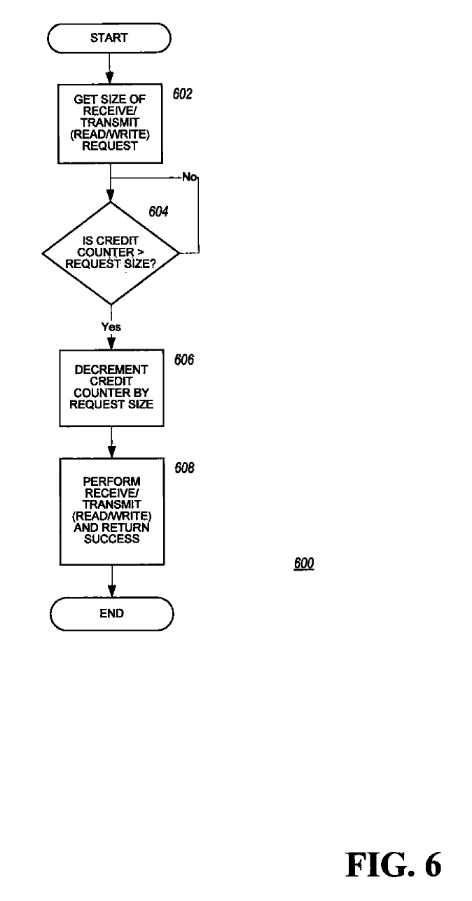

FIG. 6 illustrates a flow chart implementing a network and storage data rate limiting process 600. The rate control algorithm implemented in process 600 may be operated without any modifications to the operating system 202. To implement the rate control algorithm, the user-level scheduler library 210 instantiates a periodic timer (either in hardware or software) that invokes the timer handling function 216 within the user-level scheduler library 210. The operation of the algorithm as applied to transferring data over a network connection (not shown) by the application 214 will first be described.

When an application process/thread such as the application 214 attempts to send/receive data over the network, a credit counter is checked in step 604 to see if it has sufficient credit. The value of the credit counter is proportional to the amount of data that can be sent or received, i.e., the credit counter represents the number of units of data that can be sent or received. In step 602, the amount of data that the application 214 wishes to transmit or retrieve is determined. If the application 214 has sufficient credits as determined in step 604, the credit counter will be decremented in step 606 in proportion to the amount of data to be transferred. The data will then be transferred in step 608. If sufficient credits are not available for the data transfer to occur, as determined in step 604, the user-level scheduler library 216 will cause the application 214 to wait until sufficient credits are available to satisfy the data transfer request.

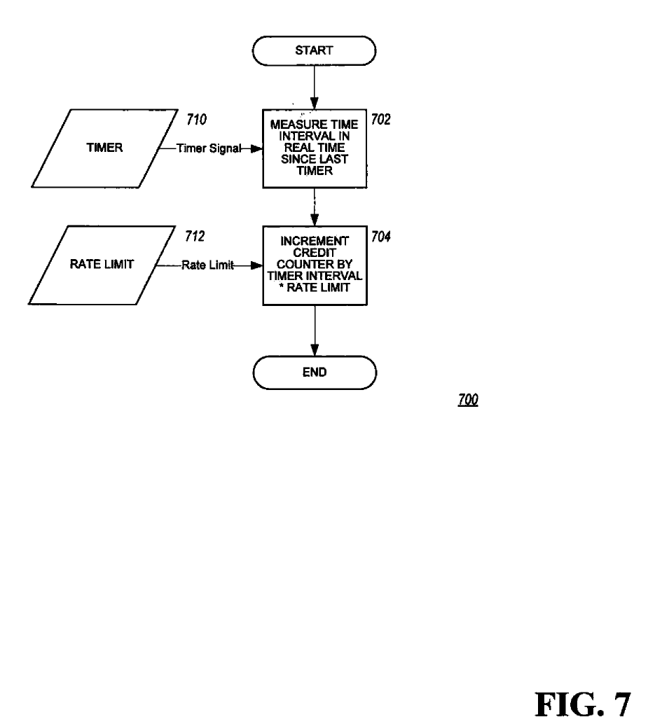

FIG. 7 illustrates a credit counter allocation process 700. Initially, the credit counter is set to 0 in one aspect of the credit counter allocation process 700. In another aspect, the credit counter is preset to a predetermined amount initially. The timer handling function 216 periodically replenishes credits in proportion to the network data transfer rate limit set for the process/thread by measuring a time interval in real time 710 from a previous time in step 702 and then incrementing the credit counter in step 704. The data transfer rate limits 712 can be set independently for read and write operations as well as on a per source or per destination basis, where the source represents the origin address of the source of data and destination represents a destination address for the destination of the data.

Network connectivity limits are implemented by intercepting communication requests that open a data channel in connection oriented networks or send/receive data in connectionless networks. The source/destination addresses are then examined to ensure that they are within the connectivity limits imposed upon the process/thread. If the source/destination addresses are not permitted by the network connectivity limits the corresponding request from the process/thread is denied.

Another aspect of the resource allocation and control system implements storage limits on data transfer rate and storage connectivity. Storage data transfer rate limits are implemented by the user-level scheduler library 216 intercepting all storage requests, including but not limited to requests for reading and writing data from/to a storage subsystem, between the application 214 and the operating system 202. Note that this method is capable of working over both local attached storage as well as remote, networked storage.

The process for controlling storage data transfer limits is similar to the process 600 as described for controlling network transfer limits shown in FIG. 6. When an application process/thread attempts to read or write data from/to storage, it checks a credit counter to see if it has sufficient credits to read/write data. The value of the credit counter is proportional to the amount of data that is being read or written, i.e., the credit counter represents the number of units of data that can be read or written. If the process/thread has sufficient credits, it decrements the credit counter in proportion to amount of data transferred and transfers the data immediately. If sufficient credits are not available, the user-level scheduler library 216 causes the process/thread to wait until sufficient credits are available to satisfy the data transfer request.

Similar to the network transfer limit process, the credit counter may be initially set to 0 or a preset limit. The timer handling function periodically replenishes credits in proportion to the storage data transfer rate limit set for the process/thread. Note that data transfer rate limits can be set independently for read and write operations as well as on a per file, per directory, per file system or per volume basis.

The storage connectivity limits are implemented by intercepting storage requests that access data on storage. The source (for instance source addresses) and destination (for instance, file, directory or file system) of the request are examined to ensure that they are within the storage connectivity limits imposed upon the process/thread. If the source/destination addresses are not permitted by the storage connectivity limits, the corresponding request from the process/thread is denied.

The various components that have been described may be comprised of hardware, software, and/or any combination thereof. For example, the libraries such as user-level scheduler library 210, the resource monitoring system and the applications such as application 214 may be software computer programs containing computer-readable programming instructions and related data files. These software programs may be stored on storage media, such as one or more floppy disks, CDs, DVDs, tapes, hard disks, PROMS, etc. They may also be stored in RAM, including caches, during execution.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently. In short, the scope of protection is limited solely by the claims that now follow. That scope is intended to be as broad as is reasonably consistent with the language that is used in the claims and to encompass all structural and functional equivalents.

The phrase “means for” when used in a claim embraces the corresponding structure and materials that have been described and their equivalents. Similarly, the phrase “step for” when used in a claim embraces the corresponding acts that have been described and their equivalents. The absence of these phrases means that the claim is not limited to any corresponding structures, materials, or acts. Moreover, nothing that has been stated or illustrated is intended to cause a dedication of any component, step, feature, object, benefit, advantage, or equivalent to the public, regardless of whether it is recited in the claims.

What is claimed is:

1. A method for controlling resources in a computing system comprising:
receiving an allocation request for a resource;
determining whether an allocation limit for the resource has been reached; and,
restricting access to the resource upon determination that the allocation limit has been reached.

2. The method of claim 1, wherein the allocation request includes an allocation size.

3. The method of claim 2, wherein the allocation size includes a requested memory size.

4. The method of claim 2, wherein the allocation size includes a requested network transfer rate.

5. The method of claim 2, wherein the allocation size includes a requested data transfer rate.

6. The method of claim 1, wherein receiving the allocation request comprises intercepting the allocation request from an application to an operating system.

7. The method of claim 1, wherein determining whether the allocation limit for the resource has been reached comprises:
retrieving an allocation request size; and,
determining if a sum of the allocation request size and an allocation counter is less than the allocation limit.

8. The method of claim 7, wherein restricting access to the resource upon determination that the allocation limit has been reached comprises:
transferring contents from a previously allocated memory to an alternate medium; and,
releasing the previously allocated memory.

9. The method of claim 1, wherein determining whether the allocation limit for the resource has been reached comprises:
retrieving an allocation request size; and,
determining if the allocation request size is greater than the allocation limit.

10. The method of claim 9, wherein restricting access to the resource upon determination that the allocation limit has been reached comprises incrementing the allocation limit based on a predetermined period upon determining the allocation request size is greater than the allocation limit.

11. The method of claim 9, wherein upon determining the allocation request size is less than the allocation limit, further comprising:
allocating the resource based on the allocation request size; and,
decrementing the allocation limit by the allocation request size.

12. A product comprising a machine-readable medium and programming embodied in the medium that, when executed by a processor, implements a method for controlling resources in a computing system comprising:
receiving an allocation request for a resource;
determining whether an allocation limit for the resource has been reached; and,
restricting access to the resource upon determination that the allocation limit has been reached.

13. The product of claim 12, wherein the allocation request includes an allocation size.

14. The product of claim 13, wherein the allocation size includes a requested memory size.

15. The product of claim 13, wherein the allocation size includes a requested network transfer rate.

16. The product of claim 13, wherein the allocation size includes a requested data transfer rate.

17. The product of claim 12, wherein receiving the allocation request comprises intercepting the allocation request from an application to an operating system.

18. The product of claim 12, wherein determining whether the allocation limit for the resource has been reached comprises:
retrieving an allocation request size; and,
determining if a sum of the allocation request size and an allocation counter is less than the allocation limit.

19. The product of claim 7, wherein restricting access to the resource upon determination that the allocation limit has been reached comprises:
transferring contents from a previously allocated memory to an alternate medium; and,
releasing the previously allocated memory.

20. The product of claim 12, wherein determining whether the allocation limit for the resource has been reached comprises:
retrieving an allocation request size; and,
determining if the allocation request size is greater than the allocation limit.

21. The product of claim 20, wherein restricting access to the resource upon determination that the allocation limit has been reached comprises incrementing the allocation limit based on a predetermined period upon determining the allocation request size is greater than the allocation limit.

22. The product of claim 20, wherein upon determining the allocation request size is less than the allocation limit, and the method further comprising:
allocating the resource based on the allocation request size; and,
decrementing the allocation limit by the allocation request size.

23. An apparatus for controlling resources in a computing system comprising:
means for receiving an allocation request for a resource;
means for determining whether an allocation limit for the resource has been reached; and,
means for restricting access to the resource upon determination that the allocation limit has been reached.

24. The apparatus of claim 23, wherein the allocation request includes an allocation size.

25. The apparatus of claim 24, wherein the allocation size includes a requested memory size.

26. The apparatus of claim 24, wherein the allocation size includes a requested network transfer rate.

27. The apparatus of claim 24, wherein the allocation size includes a requested data transfer rate.

28. The apparatus of claim 23, wherein the means for receiving the allocation request comprises means for intercepting the allocation request from an application to an operating system.

29. The apparatus of claim 23, wherein the means for determining whether the allocation limit for the resource has been reached comprises:
means for retrieving an allocation request size; and,
means for determining if a sum of the allocation request size and an allocation counter is less than the allocation limit.

30. The apparatus of claim 29, wherein the means for restricting access to the resource upon determination that the allocation limit has been reached comprises:
means for transferring contents from a previously allocated memory to an alternate medium; and,
means for releasing the previously allocated memory.

31. The apparatus of claim 23, wherein the means for determining whether the allocation limit for the resource has been reached comprises:
means for retrieving an allocation request size; and,
means for determining if the allocation request size is greater than the allocation limit.

32. The apparatus of claim 31, wherein the means for restricting access to the resource upon determination that the allocation limit has been reached comprises means for incrementing the allocation limit based on a predetermined period upon determining the allocation request size is greater than the allocation limit.

33. The apparatus of claim 31, wherein upon determining the allocation request size is less than the allocation limit, further comprising:
means for allocating the resource based on the allocation request size; and,
means for decrementing the allocation limit by the allocation request size.
